(19) United States
(12) Patent Application Publication
(10) Pub. No.: US 2016/0229947 A1
(43) Pub. Date: Aug. 11, 2016

(54) POLYUREA PREPOLYMERS

(71) Applicant: SUPER SKIN SYSTEMS, INC., LAWRENCEVILLE, GA (US)

(72) Inventor: STUART BRUCE SMITH, LAWRENCEVILLE, GA (US)

(73) Assignee: SUPER SKIN SYSTEMS, INC., LAWRENCEVILLE, GA (US)

(21) Appl. No.: 15/019,582

(22) Filed: Feb. 9, 2016

Related U.S. Application Data
(60) Provisional application No. 62/113,702, filed on Feb. 9, 2015.

(51) Int. Cl. C08G 18/80

(52) U.S. Cl. CPC C08G 18/8038; C08G 18/8054

(57) ABSTRACT

Novel polyurea prepolymer and quasi-prepolymer compositions are contemplated, the compositions being the reaction products of an isocyanate component and a secondary diamine component. Specifically, a an isocyanate component comprising uretonimine-modified 4,4′ methylene diphenyl diisocyanates are reacted with various polyamines to form prepolymers or quasi-prepolymers. The isocyanate component may additionally comprise one or more other isocyanates, including pure MDI, aliphatic HDI trimer, HDI allophanate, and aliphatic HDI biuret.

### CROSS-REFERENCE TO RELATED APPLICATIONS

This patent application claims priority to U.S. Provisional Patent Application Ser. No. 62/113,702, entitled POLYUREA PREPOLYMERS, filed Feb. 9, 2015, all of the teachings of which are incorporated herein by reference.

### STATEMENT RE: FEDERALLY SPONSORED RESEARCH/DEVELOPMENT

Not Applicable

### BACKGROUND

1. Technical Field

The present disclosure relates generally to the field of polyurea coatings and composites, and methods of making the same. More particularly, the present disclosure relates to the preparation of novel polyurea prepolymers and quasi-prepolymers.

2. Related Art

Polyureas are the reaction product of amine-containing terminated polyols reacted with isocyanates. Polyureas were developed in the 1980s for rapid process application of durable protective membranes for a myriad of products and technologies. Conventional polyurea coatings typically possess several characteristics that have made them desirable as a seamless membrane including fast, consistent reactivity and cure, moisture and temperature insensitivity during application, exceptional elastomeric quality, hydrolytically stability (i.e. low water absorption), high thermal stability, an auto catalytic nature, and non-emission of solvents or volatile organic compounds when applied.

Polyureas are generally formed as the reaction product of an isocyanate component and a polyamine resin blend. While the polyurea reaction will work with polyamine monomers or polymers, it is quite exothermic and unlikely to form orderly structures, and may even pose fire hazards in the presence of flammable substances. It is thus desirable in many industrial fields to perform the reaction in multiple stages, which serves to decrease the isocyanate content and thus the chemical energy in steps, preventing all the chemical energy from being released during the final formation of the polyurea. This is accomplished by forming polyamine prepolymers or quasi-prepolymers. This provide the polyamine in a partially reacted, viscous form where it may be conveniently mixed with a polyamine resin blend while liberating less heat when curing into a completely hardened reaction product.

An isocyanate polyurea prepolymer is generally formed from a molar ratio of isocyanate component to polyamine component just sufficient to fully saturate every functional amine of the polyamine component with an exposed isocyanate functional groups. Isocyanate quasi-prepolymers are similar to prepolymers, except that the isocyanate component is provided in a greater molar ratio than in the prepolymer, resulting in some free isocyanate component in the quasi-prepolymer. This generally allows the quasi-prepolymer to be more viscous at room temperature and thus easier to mix, with the greater isocyanate content increasing the reactivity, often allowing the final mixing step for forming the cured reaction product to occur at or near room temperature. Further, the additional free isocyanate component may permit greater tolerances in the formulation of the final mixing step for the cured reaction product.

In order to obtain cured polyurea reaction products having material characteristics beneficial for various purposes, it is desirable to utilize various different polyurea prepolymers or quasi-prepolymers, the choice of which may result in cured polyurea reaction products having vastly different material characteristics.

Therefore, new prepolymers and quasi-prepolymers are desirable.

### BRIEF SUMMARY

To solve these and other problems, a novel polyurea prepolymer is contemplated, comprising the reaction product of a isocyanate component and a secondary diamine component, wherein the isocyanate component is selected from one or more of the group consisting of: 4,4′ methylene diphenyl diisocyanate (MDI), uretonimine-modified 4,4′ MDI, hexamethylene diisocyanate (HDI) allophanate, aliphatic HDI trimer, aliphatic HDI biuret.

In such a novel polyurea prepolymer, the secondary diamine component may comprise a mixture of secondary diamines having the general formula:

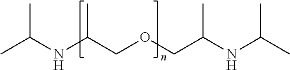

where n has a mean value of about 33.

Alternatively, the polyurea prepolymer may be formed from a secondary diamine component having the formula:

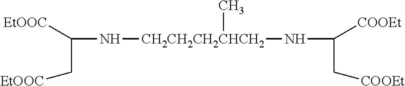

The isocyanate component of the polyurea prepolymer may comprise a mixture of uretonimine-modified 4,4′ MDIs, wherein the mixture of uretonimine-modified 4′4 MDIs have mean NCO content of about 29%. The isocyanate component may further comprise one or more of an aliphatic HDI trimer, an HDI allophanate, or an aliphatic HDI biuret.

It is further contemplated that a novel polyurea prepolymer may be formed as the reaction product of uretonimine-modified 4,4′ MDIs and poly[(3-aminopropyl)methylsiloxane-co-diphenylsiloxane].

In further embodiments, it is contemplated that the above formulations may also be implemented in a quasi-prepolymer.

### DETAILED DESCRIPTION

According to various aspects of the present disclosure, new types of polyurea prepolymers and quasi-prepolymers are contemplated. In an exemplary embodiment, a prepolyer or quasi-prepolymer is contemplated as comprising the reaction product of an isocyanate component and a secondary diamine component, with the isocyanate component being a mixture of uretonimine-modified 4,4′ methylene diphenyl diisocyanates (MDIs), wherein the mixture of uretonimine-modified 4,4′ MDIs have a mean NCO content of about 29% prior to the formation of the prepolyer. In other embodiments, the isocyanate component may comprise or further include other isocyanates, such as pure 4,4′ MDI, other MDI isomers such as 2,2′ MDI or 2,4′ MDI, aliphatic HDI trimers, HDI allophanates, or aliphatic HDI biuret.

4,4′ MDI, also referred to as bis(4-isocyanatophenyl)methane, is a common isocyanate used in various polymerization reactions to form polyurethanes. 4,4′ MDI has the following chemical structure:

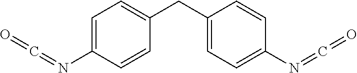 [SMILES: O=C=Nc1ccc(Cc2ccc(N=C=O)cc2)cc1]

Uretonimine-modified 4,4′ MDIs generally consist of a composition of reaction products formed from the catalyzed reaction of pure 4,4′ MDI, wherein the terminal isocyanate groups of multiple 4,4′ MDI molecules react with each other to form multifunctional uretonimine oligomers via a carbodiimide intermediate, starting with 3-functional, 6-ring uretonimine oligomers and ranging to very complex high functional oligomers. The longer the reaction is allowed to proceed before being stopped (typically via quenching), the more complex and multifunctional the aggregate reaction product will be, and the lower the resulting NCO content of the uretonimine-modified 4,4′ MDIs will be.

One way the uretonimine modification of 4,4′ MDI is generally understood to proceed is as follows:

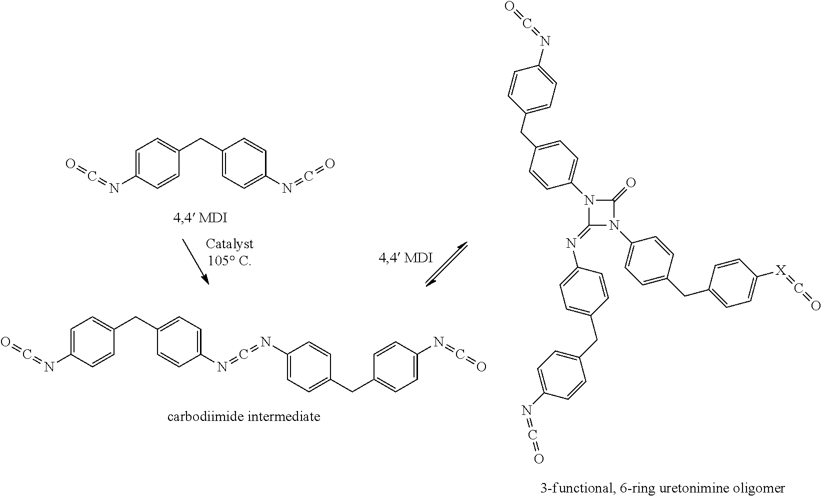

As the reaction proceeds further, more monomeric 4,4′ MDI is consumed and converted to uretonimines, and more functional and complex uretonimine-modified 4,4′ MDI oligomers are formed, including 4-functional, ten ring uretonimine oligomers and 5-functional, 12-ring oligomers. Consequently, the NCO content of the mixture of uretonimine-modified 4,4′ MDIs drops as well. Pure 4,4′ MDI has an NCO content of 33.6%, while in one embodiment, the mixture of uretonimine-modified 4,4′ MDIs have an NCO content of about 29%.

NCO content, also called isocyanate value, can be determined by the following equation, where 42 is the molecular weight of the NCO groups, f is the functionality of the isocyanate composition, and Mw is the molecular weight of the isocyanate composition:

$$Isocyanate Value = \% NCO groups = \frac{42 \times f}{Mw} \times 100 ,$$

Isocyanate prepolymers may be formed from an isocyanate curing agent and polyols or polyamines, such that a given percentage by weight (the isocyanate content) of the isocyanate functional groups remain unreacted and ready for further reaction isocyanate reactions. For example, in one exemplary embodiment, uretonimine-modified 4,4′ MDIs having a NCO content of about 29% are used as the isocyanate curing agent. However, it may be seen that in other embodiments, other isocyanate curing agents may be used to form the isocyanate prepolymer, or combinations of isocyanate curing agents, including but not limited to Pure 4,4′ MDI, other isomers of MDI such as 2,2′ or 2,4′ MDI, hexamethylene diisocyanate (HDI) Trimer, HDI Biuret, and HDI allophanate. Pure MDI, other MDI isomers, combinations of MDI isomers, or uretonimine-modified 4,4′ MDI may be made by known methods of synthesis, or obtained commercially from manufacturers such as Dow Corporation, which sells Pure MDI under the trade name ISONATE 125M, or Huntsman Corporation, which sells a mixture of about 70% 4,4′ MDI and 30% 2,4′ MDI under the trade name SUPRASEC 9150 and uretonimine MDI under the trade name Huntsman 1680.

Poly[(3-aminopropyl)methylsiloxane-co-diphenylsiloxane] is a siloxane copolymer having the general formula:

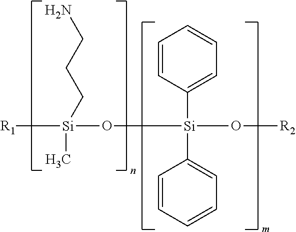

It may be seen that in certain embodiments, the poly[(3-aminopropyl)methylsiloxane-co-diphenylsiloxane] used may be many types of copolymer having varied distributions and arrangements of the (3-aminopropyl)methylsiloxane) and the diphenylsiloxane units, and that the arrangement, distribution, and number of these units may affect the final material properties of a cured polyurea reaction product incorporating poly[(3-aminopropyl)methylsiloxane-co-diphenylsiloxane] may change depending on the specific arrangement and distribution of those units. For example, a random copolymer may be utilized wherein the chance of finding a particular monomer at any given location in the polymer is directly proportional to the molar fraction of that monomer. It may also be seen that other arrangements, such as regularly alternating copolymers or periodic copolymers may be used, where the monomeric units are arranged in a repeating sequence. Likewise, it may also be seen that block copolymers or statistical copolymers may be utilized. Additionally, linear or branched copolymers may be preferred, depending on the needs of the application. Poly[(3-aminopropyl)methylsiloxane-co-diphenylsiloxane] may be synthesized via known methods of siloxane polymerization, or may be obtained commercially.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the exemplary embodiments.

What is claimed is:

1. A polyurea prepolymer comprising the reaction product of a isocyanate component and a secondary diamine component, wherein the isocyanate component is selected from one or more of the group consisting of: 4,4′ methylene diphenyl diisocyanate (MDI), uretonimine-modified 4,4′ MDI, hexamethylene diisocyanate (HDI) allophanate, aliphatic HDI trimer, aliphatic HDI biuret.

2. The polyurea prepolymer of claim 1, wherein the secondary diamine component comprises a mixture of secondary diamines having the general formula: 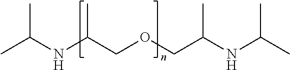
where n has a mean value of about 33.

3. The polyurea prepolymer of claim 1, wherein the secondary diamine component comprises a secondary diamine having the formula:

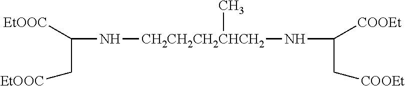

4. The polyurea prepolymer of claim 1, wherein the isocyanate component comprises a mixture of uretonimine-modified 4,4′ MDIs, wherein the mixture of uretonimine-modified 4′4 MDIs have mean NCO content of about 29%.

5. The polyurea prepolymer of claim 4, wherein the isocyanate component further comprising an aliphatic HDI trimer.

6. The polyurea prepolymer of claim 4, wherein the isocyanate component further comprises an HDI allophanate.

7. The polyurea prepolymer of claim 4, wherein the isocyanate component further comprises an aliphatic HDI biuret.

8. A polyurea quasi-prepolymer comprising the reaction product of a isocyanate component and a secondary diamine component, wherein the isocyanate component is selected from one or more of the group consisting of: 4,4′ methylene diphenyl diisocyanate (MDI), uretonimine-modified 4,4′ MDI, hexamethylene diisocyanate (HDI) allophanate, aliphatic HDI trimer, aliphatic HDI biuret.

9. The polyurea quasi-prepolymer of claim 1, wherein the secondary diamine component comprises a mixture of secondary diamines having the general formula: 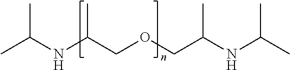
where n has a mean value of about 33.

10. The polyurea prepolymer of claim 1, wherein the secondary diamine component comprises a secondary diamine having the formula:

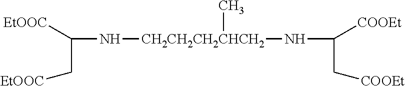

11. The polyurea quasi-prepolymer of claim 1, wherein the isocyanate component comprises a mixture of uretonimine-modified 4,4′ MDIs, wherein the mixture of uretonimine-modified 4′4 MDIs have mean NCO content of about 29%.

12. The polyurea quasi-prepolymer of claim 11, wherein the isocyanate component further comprising an aliphatic HDI trimer.

13. The polyurea quasi-prepolymer of claim 11, wherein the isocyanate component further comprises an HDI allophanate.

14. The polyurea quasi-prepolymer of claim 11, wherein the isocyanate component further comprises an aliphatic HDI biuret.

15. A polyurea prepolymer comprising the reaction product of uretonimine-modified 4,4′ methylene diphenyl diisocyanate and poly[(3-aminopropyl)methylsiloxane-co-diphenylsiloxane].

16. A polyurea quasi-prepolymer comprising the reaction product of uretonimine-modified 4,4′ methylene diphenyl diisocyanate and poly[(3-aminopropyl)methylsiloxane-co-diphenylsiloxane].
